(19) United States
(12) Patent Application Publication
(10) Pub. No.: US 2008/0230676 A1
(43) Pub. Date: Sep. 25, 2008

(54) Rubber Mounting, in Particular for a Motor-Driven Pump Unit of a Power Steering System

(76) Inventors: Volker Hansemann, Neuss (DE); Frank Hofmann, Duesseldorf (DE); Michael Scholand, Wuelfrath (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 10/593,737

(22) PCT Filed: Mar. 23, 2005
(86) PCT No.: PCT/EP2005/003124

§ 371 Date: Apr. 21, 2008

(30) Foreign Application Priority Data
Mar. 24, 2004 (DE) 20 2004 004 610.5

(51) Int. Cl. F16F 1/373

(52) U.S. Cl. 248/634

(57) ABSTRACT

A rubber mounting, in particular for a motor-driven pump unit of a power steering system, the rubber mounting has a holding flange, a bolt which starts to extend from the holding flange, a rubber element disposed on the bolt, and a fastening eye disposed on the rubber element. The bolt is waisted so that a particularly high flexibility of the rubber mounting in the case of movements in a plane perpendicular to the longitudinal axis of the bolt is achieved.

### CROSS-REFERENCE TO RELATED APPLICATIONS

This application is a national stage of International Application No. PCT/EP2005/003124 filed Mar. 23, 2005, the disclosures of which are incorporated herein by reference, and which claimed priority to German Patent Application No. 20 2004 004 610.5 filed Mar. 24, 2004, the disclosures of which are incorporated herein by reference.

### BACKGROUND OF THE INVENTION

The invention relates to a rubber mounting, in particular for a motor-driven pump unit of a power steering system, this rubber mounting having a holding flange, a bolt which starts to extend from the holding flange, a rubber element disposed on the bolt, and a fastening eye disposed on the rubber element.

In electro-hydraulically driven power steering systems a pump is driven by an electric motor. Since the pump is combined with the electric motor so as to form a compact unit, such an arrangement is denoted as a motor-driven pump unit. The motor-driven pump unit is fixed in the vehicle by means of a holding flange. For this purpose, the motor-driven pump unit is, as a rule, attached to the holding flange by a rubber mounting element, in order to prevent any noise transmission.

### BRIEF SUMMARY OF THE INVENTION

It is the object of the invention to further develop a rubber mounting of the aforementioned kind to the effect that a varying mounting characteristic is achieved, namely a comparatively high rigidity along the z-axis of the vehicle, i.e. in the vertical direction, while providing at the same time a high flexibility in the case of movements in the plane that is tensed by the x-axis and the y-axis. In other words, the mounting is to permit that the weight and accelerating forces coming from the mass of the motor-driven pump unit are supported in the vertical direction, while permitting any movements in the horizontal direction.

For this purpose it is provided for in accordance with the invention that the bolt is waisted so that a particularly high flexibility of the rubber mounting in the case of movements in a plane perpendicular to the longitudinal axis of the bolt is achieved. Thus, the bolt is vertically oriented, i.e. parallel to the z-axis, so that the rubber element directly supports on the holding flange, and high loads may be transferred in this way. In the case of loads occurring in the horizontal direction, the rubber element, on the other hand, permits comparatively large movements on account of the waisted configuration of the bolt.

Other advantages of this invention will become apparent to those skilled in the art from the following detailed description of the preferred embodiments, when read in light of the accompanying drawings.

### BRIEF DESCRIPTION OF THE DRAWINGS

The invention will be described in the following with the aid of two preferred embodiments which are represented in the accompanying drawings, in which:

FIG. 1 shows a cross section through a rubber mounting according to a first embodiment of the invention; and

FIG. 2 shows a cross section through a rubber mounting according to a second embodiment of the invention.

### DETAILED DESCRIPTION OF THE INVENTION

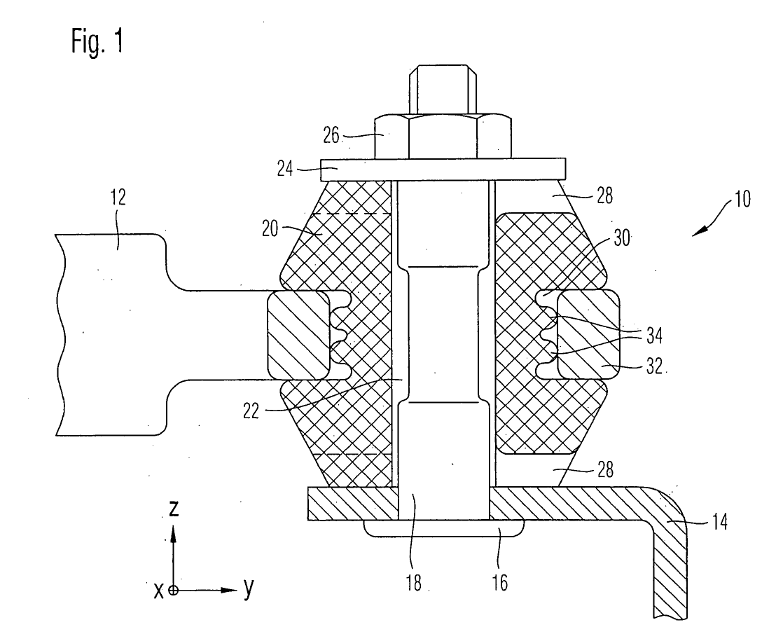

The rubber mounting 10 shown in FIG. 1 serves to attach a motor-driven pump unit 12 to a vehicle. The rubber mounting includes a holding flange 14 that ends horizontally. The opposite end is mounted so as to be vehicle-fixed. Extending through the holding flange 14 is a bolt 16 which, in the embodiment shown here, is inserted through the holding flange 14. As an alternative, it is possible as well to weld the bolt on, press-mount it, stick it on, etc.

The bolt 16 comprises a shank 18 whose center section is configured in a waisted shape. The diameter in the waisted section amounts to about ⅔ of the diameter of the shank at the two axial ends.

There is provided a rubber element 20 that is embodied as a one-piece part and comprises a continuous center opening 22, through which the shank 18 of the bolt 16 extends. The rubber element 20 is, on the whole, embodied so as to be barrel-shaped, with one of the front faces supporting on the holding flange 14. The opposite front face rests against a supporting disk 24 which is integrally embodied with a nut 26. The nut 26 is screwed on the end of the bolt 16 facing away from the holding flange 14 so that the rubber element 20 is clamped between the supporting disk 24 and the holding flange 14. On its two axial ends, the rubber element 20 comprises a plurality of ridges 28 which are oriented both in the axial and radial direction. From this follows that the rubber element 20 does not support with a continuous surface on the holding flange 14, on the supporting disk 24, and on the shank 18 of the bolt 16, but only with the outer surface of the respective ridge.

Along its equator, the rubber element 20 is provided with a surrounding groove 30, in which there is disposed a fastening eye 32 that is firmly connected to the motor-driven pump unit 12. On the bottom of the groove 30, there are embodied two ribs 34 so that the fastening eye 32, when viewed in the radial direction, rests against the rubber element 20 in two annular surfaces.

Any weight and accelerating forces which are exerted by the motor-driven pump unit 12 on the holding flange 14 and which act in the z-direction are taken up and supported by a comparatively large cross section of the rubber element 20. The ridges 28, however, provide for a sufficient flexibility. Any movements in the horizontal direction, i.e. in a plane tensed by the x-axis and the y-axis, are cushioned with a large flexibility, because on account of the waisted configuration of the shank 18 of the bolt 16 the rubber element is, to a high degree, capable of yielding in the horizontal direction. The ribs 34 additionally provide for a high flexibility.

Should the rubber element 20 fail, the supporting disk 24, whose outside diameter is larger than the inside diameter of the opening in the fastening eye 32, will prevent the latter from disengaging from the holding flange 14.

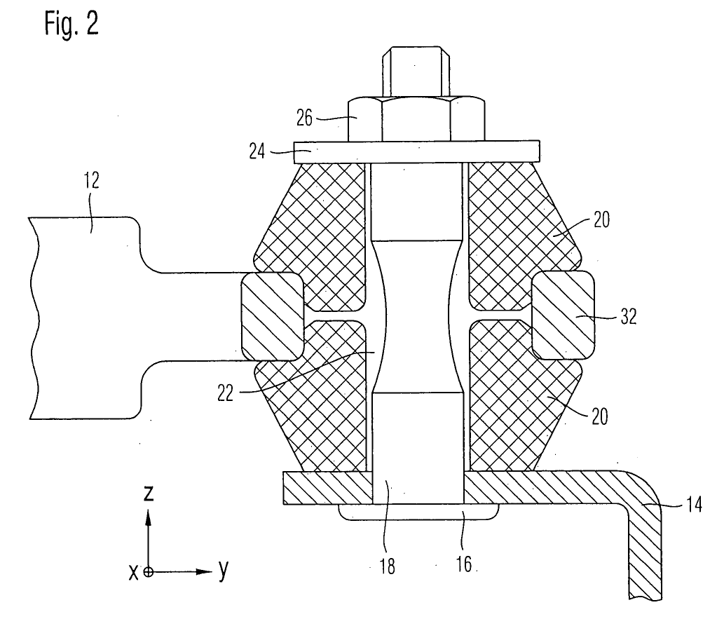

As regards its function and construction, the rubber mounting shown in FIG. 2 in principle corresponds to the mounting shown in FIG. 1. The difference is that in the embodiment shown in FIG. 2 a two-piece rubber element 20 is used. Thus, the rubber mounting may more easily be attached to the fastening eye 32.

A further distinction between the first and second embodiment is that in the second embodiment the rubber element 20 is configured without the ridges 28. Thus, a higher rigidity is achieved.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A rubber mounting, in particular for a motor-driven pump unit of a power steering system, said rubber mounting having a holding flange, a bolt which starts to extend from the holding flange, a rubber element disposed on the bolt, and a fastening eye disposed on the rubber element, wherein the bolt is waisted so that a particularly high flexibility of the rubber mounting in the case of movements in a plane perpendicular to the longitudinal axis of the bolt is achieved.

2. The rubber mounting according to claim 1, wherein at the end of the bolt facing away from the holding flange there is mounted a supporting disk.

3. The rubber mounting according to claim 2, wherein the bolt is inserted through the holding flange and the supporting disk is part of a nut which is screwed on the bolt.

4. The rubber mounting according to claim 2, wherein the outside diameter of the supporting disk is larger than the inside diameter of the fastening eye.

5. The rubber mounting according to claim 1, wherein the rubber element is provided with ridges at its axial ends.

6. The rubber mounting according to claim 5, wherein the ridges are radially oriented so that they rest against the bolt.

7. The rubber mounting according to claim 5, wherein the ridges are axially oriented so that they rest against the holding flange and the supporting disk, respectively.

8. The rubber mounting according to claim 1, wherein in the region in which the fastening eye is disposed the rubber mounting is provided with radially oriented ribs.

9. The rubber mounting according claim 1, wherein the length of the waisted section of the bolt is greater than the thickness of the fastening eye.

10. The rubber mounting according to claim 1, wherein the rubber element is embodied as a one-piece part.

11. The rubber mounting according to claim 1, wherein the rubber element is embodied as a two-piece part.
